(19) United States
(12) Patent Application Publication
(10) Pub. No.: US 2019/0057081 A1
(43) Pub. Date: Feb. 21, 2019

(54) METHOD AND APPARATUS FOR GENERATING NATURAL LANGUAGE

(71) Applicant: SAMSUNG ELECTRONICS CO., LTD., Suwon-si (KR)

(72) Inventors: Junhwi CHOI, Seongnam-si (KR); Young-Seok KIM, Suwon-si (KR); Sang Hyun YOO, Seoul (KR); Jehun JEON, Suwon-si (KR)

(73) Assignee: SAMSUNG ELECTRONICS CO., LTD., Suwon-si (KR)

(21) Appl. No.: 15/837,626

(22) Filed: Dec. 11, 2017

(30) Foreign Application Priority Data
Aug. 18, 2017 (KR) 10-2017-0105066

(51) Int. Cl. G06F 17/27; G10L 25/30

(52) U.S. Cl. CPC G06F 17/2785; G06Q 30/0251; G10L 25/30

(57) ABSTRACT

A natural language generation method and apparatus are provided. The natural language generation apparatus converts an input sentence to a first vector using a first neural network model-based encoder, determines whether a control word is to be provided based on a criterion, and converts the first vector to an output sentence using a neural network model-based decoder, based on whether the control word is to be provided.

### CROSS-REFERENCE TO RELATED APPLICATIONS

This application claims the benefit under 35 USC § 119(a) of Korean Patent Application No. 10-2017-0105066, filed on Aug. 18, 2017, in the Korean Intellectual Property Office, the entire disclosure of which is incorporated herein by reference for all purposes.

### BACKGROUND

### 1. Field

The following description relates to a natural language processing technology.

### 2. Description of Related Art

Natural language generation technologies may be classified into a rule-based method and a neural network-based method. The rule-based artificially sets a rule to output a desired output sentence in response to an input sentence. The neural network-based method adjusts parameters of a neural network to output a desired output sentence by training the parameters using a plurality of training sentences.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of generating a natural language, the method including converting an input sentence to a first vector using a first neural network model-based encoder, determining whether a control word is to be provided based on a condition, and converting the first vector to an output sentence using a neural network model-based decoder based on whether the control word is to be provided.

The converting of the first vector to the output sentence may include, in response to a determination that the control word is to be provided converting the control word to a second vector using a second neural network model-based encoder, and converting the first vector to the output sentence based on the second vector using the decoder.

The converting of the first vector to the output sentence may include, converting the first vector to the output sentence using the decoder, in response to a determination that the control word is not to be provided.

The determining of whether the control word is to be provided may include determining whether the control word is to be provided based on a similarity between the first vector and a reference vector.

The determining of whether the control word is to be provided may include recognizing a conversation pattern of the input sentence and a sentence that is input prior to the input sentence, and determining whether the control word is to be provided based on whether the recognized conversation pattern corresponds to a reference pattern.

The determining of whether the control word is to be provided may include determining whether the control word is to be provided based on any one or any combination of whether a point in time at which the input sentence is input corresponds to a preset time, whether the input sentence is input in a preset conversational turn, or a preset frequency of providing the control word.

The control word may include a content word that is a target of an advertisement.

The control word may include a function word that is used to determine a structure of a sentence.

The control word may include a function word to perform a function in response to the input sentence.

In another general aspect, there is provided a method of training a natural language generation apparatus, the method including converting a training sentence to a first vector using a first neural network model-based encoder, determining whether a control word is to be provided based on a criterion, converting the first vector to an output sentence using a neural network model-based decoder based on whether the control word is to be provided, and training the first encoder and the decoder by evaluating an accuracy of the output sentence.

The converting of the first vector to the output sentence may include, in response to a determination that the control word is to be provided converting the control word to a second vector using a second neural network model-based encoder, and converting the first vector to the output sentence based on the second vector using the decoder, and the training of the first encoder and the decoder may include training the first encoder, the second encoder and the decoder by evaluating the accuracy of the output sentence.

The converting of the first vector to the output sentence may include, converting the first vector to the output sentence using the decoder, in response to a determination that the control word is not to be provided.

The determining of whether the control word is to be provided may include determining whether the control word is to be provided based on a similarity between the first vector and a reference vector, and the training of the first encoder and the decoder may include modulating the criterion by evaluating the accuracy of the output sentence.

The determining of whether the control word is to be provided may include recognizing a conversation pattern for the training sentence and a sentence that is input prior to the training sentence, and determining whether the control word is to be provided based on whether the recognized conversation pattern corresponds to a reference pattern, and the training of the first encoder and the decoder may include modulating the criterion by evaluating the accuracy of the output sentence.

The training sentence may include the input sentence and a natural language output sentence corresponding to the input sentence, and the evaluating of the accuracy of the output sentence may include a comparison of the natural language output sentence with the output sentence.

In another general aspect, there is provided an apparatus for generating a natural language, the apparatus including a processor configured to convert an input sentence to a first vector using a first neural network model-based encoder, determine whether a control word is to be provided based on a criterion, and convert the first vector to an output sentence using a neural network model-based decoder based on whether the control word is to be provided.

The apparatus may include a second neural network model-based encoder configured to convert the control word to a second vector, in response to a determination that the control word is to be provided, and the decoder may be configured to convert the first vector to the output sentence based on the second vector.

The apparatus may include a memory coupled to the processor, the memory may include an instruction executed by the processor, and the memory may be configured to store the input sentence, the first vector to which the input sentence is converted, the control word, one or more criterion used to determine whether the control word is to be provided, the second vector to which the control word is converted, a result obtained by combining the first vector and the second vector, and the output sentence.

In another general aspect, there is provided an apparatus for training a natural language generation apparatus, the apparatus including a processor configured to convert a training sentence to a first vector using a first neural network model-based encoder, determine whether a control word is to be provided based on a criterion, convert the first vector to an output sentence using a neural network model-based decoder based on whether the control word is to be provided, and train the first encoder and the decoder by evaluating an accuracy of the output sentence.

The apparatus may include a memory coupled to the processor, the memory may store an instruction executed by the processor to convert the training sentence to the first vector, to determine whether to provide the control word, to convert the first vector to the output sentence, and to evaluate the accuracy of the output sentence.

Other features and aspects will be apparent from the following detailed description, the drawings, and the claims.

### BRIEF DESCRIPTION OF THE DRAWINGS

FIG. 1 is a diagram illustrating an example of a configuration of an apparatus to generate a natural language.

FIG. 2 is a diagram illustrating an example of a method of generating a natural language.

FIG. 3 is a diagram illustrating an example of a relationship between neural network models included in a natural language generation apparatus.

FIG. 4 is a diagram illustrating an example of a configuration of a natural language generation apparatus.

FIG. 5 is a diagram illustrating an example of a method of training a natural language generation apparatus.

FIG. 6 is a diagram illustrating an example of a configuration of an apparatus for training a natural language generation apparatus.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component or intervening components may be present. As used herein, the singular forms are intended to include the plural forms as well, unless the context clearly indicates otherwise.

Hereinafter, examples will be described in detail with reference to the accompanying drawings. In the following description, it should be noted that the same elements will be designated by the same reference numerals, wherever possible, even though they are shown in different drawings.

FIG. 1 illustrates an example of a configuration of an apparatus to generate a natural language.

Referring to FIG. 1, a natural language generation apparatus 100 communicates with a user 101. When the user 101 inputs an input sentence to the natural language generation apparatus 100, the natural language generation apparatus 100 outputs an output sentence corresponding to the input sentence to the user 101. For example, the natural language generation apparatus 100 outputs the output sentence corresponding to the input sentence using a neural network model that is included in the natural language generation apparatus 100 and that is trained through a training process. The natural language generation apparatus 100 controls, based on a control word, the output sentence that is output in response to the input sentence. The neural network model may be referred to as an “artificial neural network model.”

The natural language generation apparatus 100 is applicable to a field of natural language processing. Natural language processing refers to a technology of processing actually used languages to allow a computer to understand the actually used languages. In an example, the natural language generation apparatus 100 is applicable to a dialog system that receives an input sentence from a user and performs a function. In another example, the natural language generation apparatus 100 is applicable to a dialog system that receives an input sentence from a user and provides advertisements for a product or services. In another example, the natural language generation apparatus 100 is applicable to a dialog system that provides advertisements for services or products based on a preset criterion regardless of an input sentence of a user.

The natural language generation apparatus 100 includes a neural network model. The neural network model is stored in a memory of the natural language generation apparatus 100. The neural network model is a model in which artificial neurons that form a network by connecting synapses change a connection strength of the synapses through training to have a problem solving ability. The connection strength of the synapses is referred to as a “weight.” The neural network model includes a plurality of layers, for example, an input layer, a hidden layer and an output layer.

In an example, the natural language generation apparatus 100 includes an encoder and a decoder to process an input sentence. The encoder converts an input sentence to a vector. The decoder converts a vector to an output sentence. The vector is, for example, an embedding vector. The embedding vector is a vector that represents a structure and a meaning of a sentence. The encoder and the decoder are implemented by various neural network models, such as, for example, the encoder and the decoder each include a convolutional neural network (CNN) or a recurrent neural network (RNN).

In an example, the encoder of the natural language generation apparatus 100 includes a first encoder and a second encoder. The first encoder converts an input sentence input by the user 101 to a first vector. The second encoder converts a control word to a second vector. The decoder converts the first vector to an output sentence. In another example, the decoder combines the first vector and the second vector and converts a result obtained by combining the first vector and the second vector to an output sentence.

In an example, each of the first encoder, the second encoder and the decoder includes a CNN. The CNN is a neural network including a convolutional layer and a pooling layer. The convolutional layer is configured to perform a convolution operation by moving a mask. The mask is referred to as, for example, a window or a filter. The convolutional layer reduces a loss of spatial information by maintaining an input dimension in comparison to a fully connected layer. The pooling layer is configured to reduce a quantity of data while maintaining a number of channels.

In another example, each of the first encoder, the second encoder and the decoder includes an RNN. The RNN is a neural network to receive an input of consecutive data and reflect a result obtained by processing previous data in current data. Each of nodes included in a hidden layer has a recurrent weight, and accordingly the RNN remembers the result obtained by processing the previous data.

The neural network model is trained using a plurality of training corpora. A training corpus is a training collection of texts. In a training operation, the neural network model adjusts a weight using the plurality of training corpora. The neural network model converts an input sentence to an output sentence based on the adjusted weight. A conversion result depends on a training corpus trained in the training operation.

In an example, the neural network model is trained based on a control word together with a training corpus. In this example, the control word is a word to perform a function or a word associated with a target of an advertisement. The neural network model is trained together with the control word, and accordingly the natural language generation apparatus 100 outputs a sentence associated with a target of an advertisement, or performs a function in response to an input sentence.

Thus, the natural language generation apparatus 100 controls the output sentence based on the control word instead of determining an output corresponding to an input sentence by a training corpus only. The natural language generation apparatus 100 is trained based on a training corpus including a pair of a natural language input and a natural language output, outputs a natural output sentence corresponding to an input sentence, and additionally acquires a control possibility based on the control word. The natural language generation apparatus 100 is applicable to, for example, a field of advertising or services that perform a function based on a control possibility for an output sentence.

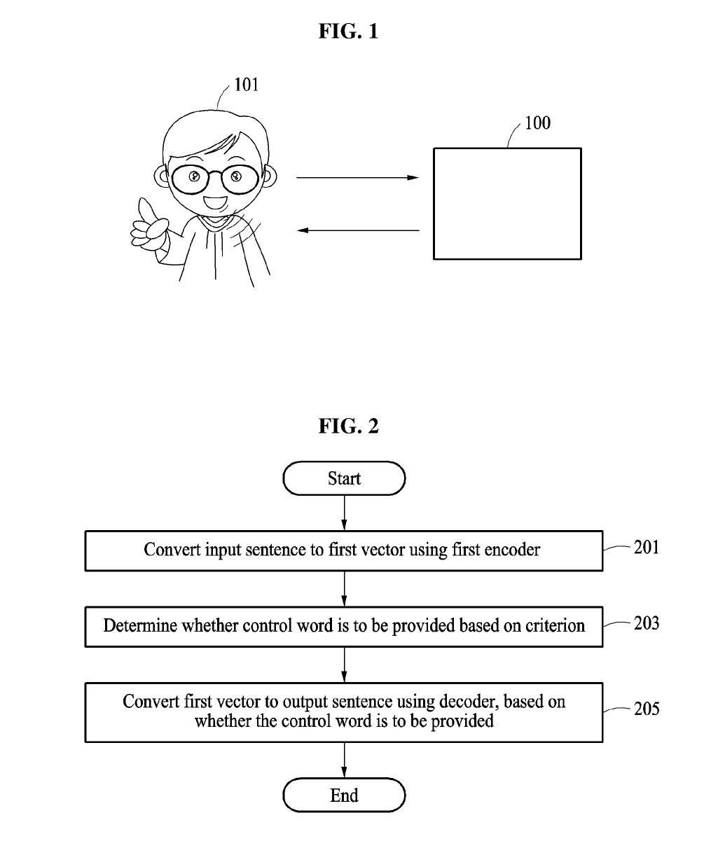

FIG. 2 illustrates an example of a method of generating a natural language. The operations in FIG. 2 may be performed in the sequence and manner as shown, although the order of some operations may be changed or some of the operations omitted without departing from the spirit and scope of the illustrative examples described. Many of the operations shown in FIG. 2 may be performed in parallel or concurrently. One or more blocks of FIG. 2, and combinations of the blocks, can be implemented by special purpose hardware-based computer that perform the specified functions, or combinations of special purpose hardware and computer instructions. In addition to the description of FIG. 2 below, the descriptions of FIG. 1 is also applicable to FIG. 2, and are incorporated herein by reference. Thus, the above description may not be repeated here.

Referring to FIG. 2, in operation 201, the natural language generation apparatus 100 of FIG. 1 converts an input sentence to a first vector using a first encoder that is based on a neural network model.

In operation 203, the natural language generation apparatus 100 determines whether a control word is to be provided based on a criterion. For example, when an input sentence is input, the natural language generation apparatus 100 determines whether a control word is to be input together with the input sentence.

When it is determined that the control word is not to be input, the natural language generation apparatus 100 does not input the control word and outputs an output sentence. When it is determined that the control word is to be input, the natural language generation apparatus 100 determines a control word that is to be used, and inputs the control word together with the input sentence.

For example, when the input sentence includes a business name of a company, the natural language generation apparatus 100 inputs a product name associated with the business name of the company as a control word. The natural language generation apparatus 100 performs advertising of a product of the company.

In operation 205, the natural language generation apparatus 100 converts the first vector to an output sentence using a decoder that is based on a neural network model, based on whether the control word is to be provided.

When it is determined that the control word is to be provided, the natural language generation apparatus 100 converts the control word to a second vector using a second encoder. To provide a control possibility, the natural language generation apparatus 100 converts the control word to the second vector using a separate second encoder, embeds the second vector in the first vector, and provides both the first vector and the second vector as inputs of the decoder. Also, the natural language generation apparatus 100 converts the first vector to the output sentence based on the second vector using the decoder.

When it is determined that the control word is not to be provided, the natural language generation apparatus 100 converts the first vector to the output sentence using the decoder. Accordingly, the natural language generation apparatus 100 outputs the same result as that of a general natural language processing system that does not use a control word, and outputs a natural output sentence corresponding to the input sentence based on a training corpus.

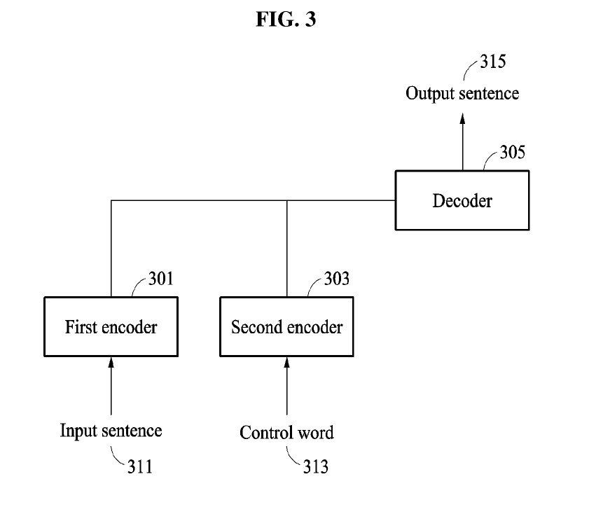

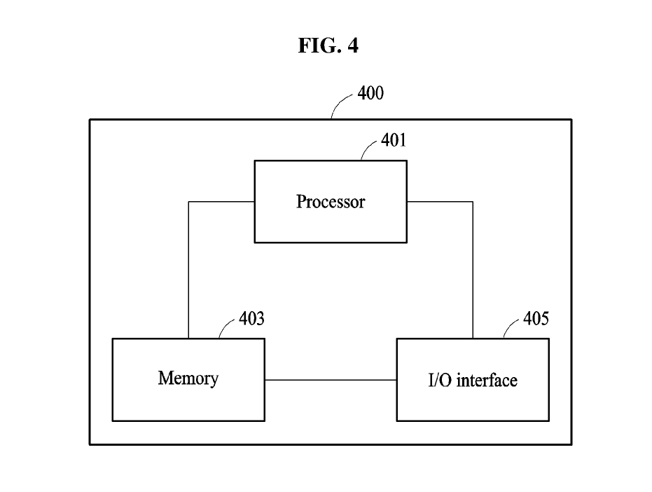

FIG. 3 illustrates an example of a relationship between neural network models included in a natural language generation apparatus.

Referring to FIG. 3, the natural language generation apparatus 100 of FIG. 1 includes a first encoder 301, a second encoder 303 and a decoder 305. In an example, each of the first encoder 301, the second encoder 303, and the decoder 305 uses a neural network model. For example, each of the first encoder 301, the second encoder 303 and the decoder 305 includes a CNN or an RNN, however, there is no limitation thereto.

In an example, when the first encoder 301 includes a CNN, the natural language generation apparatus 100 receives an input sentence 311, for example, a sentence “What shall we eat today?,” and outputs a first vector using a convolutional layer and a pooling layer. In an example, the first vector is a vector including a numeral that represents each syllable or word as a probability.

In another example, when the first encoder 301 includes an RNN, the natural language generation apparatus 100 calculates a first probability of a word “today” in an input sentence 311, for example, a sentence “What shall we eat today?.” When a word “What” is input, the natural language generation apparatus 100 calculates a second probability by reflecting the first probability. When a phrase “shall we eat” is input, the natural language generation apparatus 100 calculates a third probability by reflecting the second probability. Thus, the natural language generation apparatus 100 generates a more accurate vector by accumulating results of previous inputs in a sequential manner using the RNN.

In an example, the natural language generation apparatus 100 determines whether a control word 313 is to be provided based on a similarity between the first vector and a reference vector. For example, when the first vector is “0.4, 0.1, 0.9” and the reference vector is “0, 0, 1,” a difference between a third term of the reference vector and a third term of the first vector is “0.1.” Because the difference of “0.1” is greater than a threshold of “0.05,” the natural language generation apparatus 100 determines that the first vector is similar to the reference vector. The natural language generation apparatus 100 selects “Saewookkang” corresponding to “0, 0, 1” as the control word 313.

In another example, the natural language generation apparatus 100 recognizes a conversation pattern of the input sentence 311 and a sentence that is input prior to the input sentence 311, and determines whether the control word 313 is to be provided based on whether the recognized conversation pattern satisfies a reference pattern. The natural language generation apparatus 100 derives a pattern by analyzing a history of the input sentence 311, determines a similarity between the pattern and a preset pattern, and determines whether the control word 313 is to be provided.

In another example, the natural language generation apparatus 100 determines whether the control word 313 is to be provided based on the time at which the input sentence 311 is provided, when a point in time at which the input sentence 311 is input corresponds to a preset time, a control word may be provided. For example, when a sentence is input at 11 p.m., the natural language generation apparatus 100 outputs a sentence “It is time to go to bed.”

In another example, the natural language generation apparatus 100 determines whether the control word 313 is to be provided, based on whether the input sentence 311 is input in a preset conversational turn. For example, the natural language generation apparatus 100 outputs a sentence “Saewookkang is delicious” every time “30” input sentences 311 are input by a user.

In another example, the natural language generation apparatus 100 determines whether the control word 313 is to be provided based on a preset frequency of providing the control word 313. For example, the natural language generation apparatus 100 outputs a sentence “Saewookkang is delicious” once per 10 minutes.

When it is determined that the control word 313 is to be provided, the natural language generation apparatus 100 embeds the second vector in the first vector and outputs an output sentence 315 using the decoder 305.

For example, when the second encoder 303 includes a CNN, the natural language generation apparatus 100 converts, using the second encoder 303, a word “Saewookkang” to the second vector based on a convolutional layer and a pooling layer. The natural language generation apparatus 100 combines the first vector and the second vector. For example, the natural language generation apparatus 100 embeds the second vector in the first vector. When the decoder 305 includes a CNN, the natural language generation apparatus 100 applies a convolutional layer and a pooling layer to a combined vector generated by combining the first vector and the second vector, and outputs a sentence “I ate Saewookkang” as the output sentence 315.

For example, when the decoder 305 includes an RNN and when a combined vector generated by combining the first vector and the second vector is “0.1, 0.4, 0.3,” the natural language generation apparatus 100 reflects a result obtained by processing “0.1” in response to an input of “0.4.” Also, the natural language generation apparatus 100 reflects a result obtained by processing “0.1” in response to an input of “0.3.” Accordingly, the natural language generation apparatus 100 outputs the output sentence 315 by accumulating terms of the combined vector.

In an example, the control word 313 includes a content word that is a target of an advertisement. The natural language generation apparatus 100 outputs the output sentence 315 in response to an input of the input sentence 311 by a user. For example, when the user asks a question about a product or a company, the natural language generation apparatus 100 inputs a name of the product or the company as the control word 313 after a preset turn is over, and outputs a positive sentence associated with the product or the company or a sentence that induces a purchase of the product.

In another example, the control word 313 includes a function word to determine a structure of a sentence. The natural language generation apparatus 100 provides a function word to perform a function in response to the input sentence 311 of the user. The natural language generation apparatus 100 interprets the input sentence 311 and determines that the user desires a function. The natural language generation apparatus 100 inputs a function word corresponding to the function desired by the user as the control word 313. The natural language generation apparatus 100 outputs a sentence that induces the function, based on the control word 313.

FIG. 4 illustrates an example of a configuration of a natural language generation apparatus 400.

Referring to FIG. 4, the natural language generation apparatus 400 includes at least one processor, for example, a processor 401, at least one memory, for example, a memory 403, and an input/output (I/O) interface 405. The processor 401 and memory 403 are further described below.

The memory 403 stores instructions that are to be executed by the processor 401. Also, the memory 403 stores an input sentence input by a user, a first vector to which the input sentence is converted, a control word, a criterion used to determine whether the control word is to be provided, a second vector to which the control word is converted, a result obtained by combining the first vector and the second vector, or an output vector to which the result is converted using a decoder.

The I/O interface 405 receives an input sentence from a user. In an example, the I/O interface 405 includes a touch screen and other input/output interfaces, such as, for example, a microphone to receive voice from a user, a keyboard a button, a joystick, a click wheel, a scrolling wheel, a touch pad, a keypad, a mouse, a microphone, a camera, or a wired and wireless communication device connected to an external network.

The processor 401 converts an input sentence to a first vector using a first encoder that is based on a neural network model. The processor 401 uses a CNN or RNN as the first encoder. The memory 403 stores parameters of a neural network model trained through a training process.

The processor 401 determines whether a control word is to be provided based on a criterion. The criterion is determined based on the input sentence, or determined regardless of the input sentence. In an example, the processor 401 compares the first vector to which the input sentence is converted with a reference vector, and determines whether the control word is to be provided. In another example, the processor 401 determines whether the control word is to be provided, based on a frequency of providing the control word or a point in time at which the control word is provided, regardless of the input sentence.

The processor 401 converts the first vector to an output sentence using a decoder that is based on a neural network model, based on whether the control word is to be provided. When it is determined that the control word is to be provided, the processor 401 combines the first vector and the second vector to which the control word is converted, and converts a combination result as an output sentence using the decoder. When it is determined that the control word is not to be provided, the processor 401 inputs the first vector to the decoder and converts the first vector to the output sentence.

The I/O interface 405 outputs the output sentence to which the first vector is converted using the decoder. The I/O interface 405 includes, for example, a speaker to output sound, or a display to visually display an output sentence. In an example, the display is a physical structure that includes one or more hardware components that provide the ability to render a user interface and/or receive user input. The display can encompass any combination of display region, gesture capture region, a touch sensitive display, and/or a configurable area. In an example, the display can be embedded in the natural language generation apparatus 400. In an example, the natural language generation apparatus 400 is an external peripheral device that may be attached to and detached from the natural language generation apparatus 400. The display may be a single-screen or a multi-screen display. A single physical screen can include multiple displays that are managed as separate logical displays permitting different content to be displayed on separate displays although part of the same physical screen. The display may also be implemented as an eye glass display (EGD), which includes one-eyed glass or two-eyed glasses. In an example, the display is a head-up display (HUD) or a vehicular infotainment system.

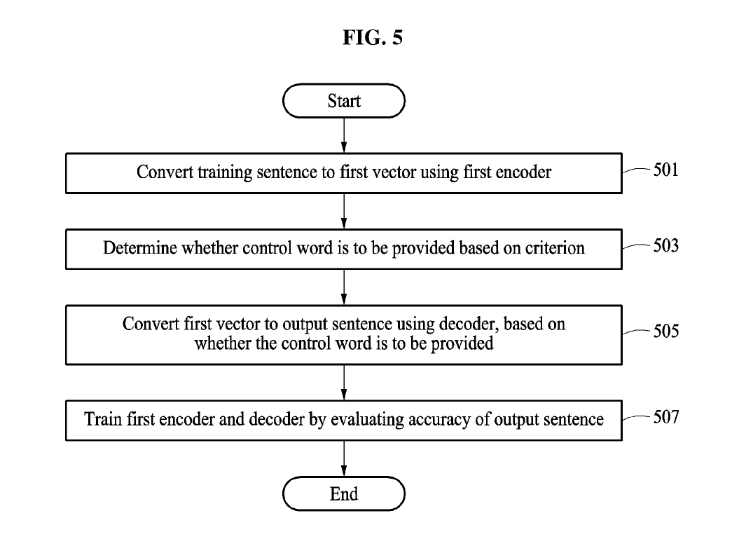

FIG. 5 illustrates an example of a method of training a natural language generation apparatus. The operations in FIG. 5 may be performed in the sequence and manner as shown, although the order of some operations may be changed or some of the operations omitted without departing from the spirit and scope of the illustrative examples described. Many of the operations shown in FIG. 5 may be performed in parallel or concurrently. One or more blocks of FIG. 5, and combinations of the blocks, can be implemented by special purpose hardware-based computer that perform the specified functions, or combinations of special purpose hardware and computer instructions. In addition to the description of FIG. 5 below, the descriptions of FIGS. 1-4 are also applicable to FIG. 5, and are incorporated herein by reference. Thus, the above description may not be repeated here.

Referring to FIG. 5, in operation 501, an apparatus (hereinafter, referred to as a “training apparatus”) for training the natural language generation apparatus converts a training sentence to a first vector using a first encoder that is based on a neural network model. The training sentence is referred to as a “training corpus.”

The training sentence includes a pair of a natural language input sentence and a natural language output sentence corresponding to the natural language input sentence. The training sentence reflects a flow of a natural conversation in a variety of situations. Also, the training sentence reflects a flow of a natural conversation on various topics. As an amount of training sentences increases, the training apparatus more accurately trains the natural language generation apparatus.

The training sentence includes, for example, a training sentence corresponding to a control word. When a control word is a content word, for example, a company name or product name, the training apparatus trains the natural language generation apparatus using a training sentence that includes the company name or product name as an input sentence and advertisement content as an output sentence.

For example, the training apparatus trains the natural language generation apparatus to output a positive output sentence associated with a “◯◯ company,” using a training sentence that includes an input sentence “What do you think of the ◯ ◯ company?” and a control word “◯◯ company” as inputs and that includes “◯◯ company is very good, and the XX product of this company is really well made” as an output.

When the control word is a function word to perform or induce a function, the training apparatus trains the natural language generation apparatus using a training sentence that includes the control word as an input sentence and a sentence corresponding to the control word as an output sentence. The sentence corresponding to the control word induces the function.

In operation 503, the training apparatus determines whether a control word is to be provided based on a criterion.

In an example, the training apparatus determines whether the control word is to be provided based on a similarity between the first vector and a reference vector. The training apparatus trains the criterion by evaluating an accuracy of an output sentence.

In another example, the training apparatus recognizes a conversation pattern of the training sentence and a sentence that is input prior to the training sentence. The training apparatus determines whether the control word is to be provided based on whether the recognized conversation pattern satisfies a reference pattern. The training apparatus trains the criterion by evaluating an accuracy of an output sentence.

In operation 505, the training apparatus converts the first vector to an output sentence using a decoder that is based on a neural network model, based on whether the control word is to be provided.

In an example, when it is determined that the control word is to be provided, the training apparatus converts a training sentence including the control word to a second vector using a second encoder, combines the first vector and the second vector, and inputs a combination result to the decoder. The training apparatus allows the decoder to output the output sentence, compares the output sentence with an output sentence included in the training sentence, and determines an accuracy.

In another example, when it is determined that the control word is not to be provided, the training apparatus inputs the first vector to the decoder and outputs the output sentence using the decoder. The training apparatus compares the output sentence output using the decoder with an output sentence included in the training sentence, and determines an accuracy.

In operation 507, the training apparatus trains the first encoder and the decoder by evaluating the accuracy of the output sentence.

In an example, when it is determined that the control word is to be provided, the training apparatus converts the control word to a second vector using a second encoder. The training apparatus converts the first vector to the output sentence based on the second vector using the decoder. The training apparatus trains the first encoder, the second encoder and the decoder by evaluating the accuracy of the output sentence.

In another example, when it is determined that the control word is not to be provided, the training apparatus converts the first vector to the output sentence using the decoder. The training apparatus trains the first encoder and the decoder by evaluating the accuracy of the output sentence.

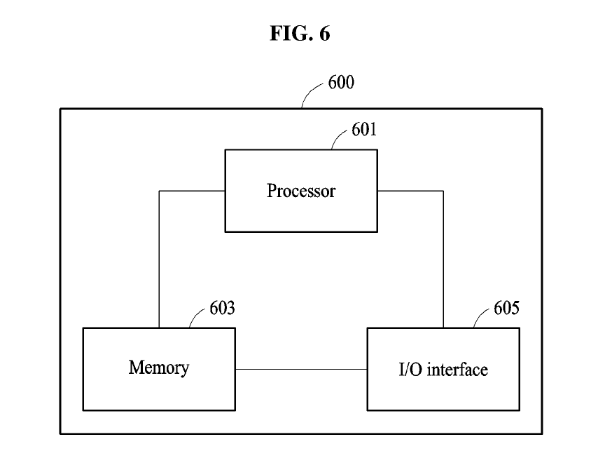

FIG. 6 illustrates an example of a configuration of a training apparatus 600. Referring to FIG. 6, the training apparatus 600 includes at least one processor, for example, a processor 601, at least one memory, for example, a memory 603, and an I/O interface 605. The processor 601, memory 603, and I/O interface 605 may correspond to the processor 401, memory 403, and input/output (I/O) interface 405 depicted in FIG. 4. In addition to the description of FIG. 6 below, the descriptions of corresponding elements of FIG. 4 are also applicable to FIG. 6, and are incorporated herein by reference. Thus, the above description may not be repeated here.

The memory 603 stores instructions that are to be executed by the processor 601. Also, the memory 603 stores a plurality of training sentences, a first vector corresponding to an input sentence included in a training sentence, a second vector corresponding to a control word included in the training sentence, and a result obtained by combining the first vector and the second vector. Furthermore, the memory 603 stores an output sentence obtained by conversion by a decoder, a variable used as a criterion, and a parameter corresponding to each variable. In addition, the memory 603 stores a first encoder, a second encoder and a decoder that are to be trained.

The I/O interface 605 receives an input sentence included in a training sentence. The I/O interface 605 includes, for example, a wired and wireless communication device connected to an external network. The I/O interface 605 outputs an output sentence obtained by conversion by a decoder.

The processor 601 converts a training sentence to a first vector using a first encoder that is based on a neural network model. The processor 601 determines whether a control word is to be provided based on a criterion. The processor 601 converts the first vector to an output sentence using a decoder that is based on a neural network model, based on whether the control word is to be provided. The processor 601 trains the first encoder and the decoder by evaluating an accuracy of the output sentence.

The natural language generation apparatuses 100 and 400, the first encoder 301, the second encoder 303, the decoder 305, the training apparatus 600 and other apparatuses, units, modules, devices, and other components described herein with respect to FIGS. 1, 3, 4 and 6 are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 2 and 5 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In one example, the instructions or software includes at least one of an applet, a dynamic link library (DLL), middleware, firmware, a device driver, an application program storing the method of preventing the collision. In one example, the instructions or software include machine code that is directly executed by the processor or computer, such as machine code produced by a compiler. In another example, the instructions or software include higher-level code that is executed by the processor or computer using an interpreter. Programmers of ordinary skill in the art can readily write the instructions or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer can execute the instructions.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of generating a natural language, the method comprising:
converting an input sentence to a first vector using a first neural network model-based encoder;
determining whether a control word is to be provided based on a condition; and
converting the first vector to an output sentence using a neural network model-based decoder based on whether the control word is to be provided.

2. The method of claim 1, wherein the converting of the first vector to the output sentence comprises, in response to a determination that the control word is to be provided:
converting the control word to a second vector using a second neural network model-based encoder; and
converting the first vector to the output sentence based on the second vector using the decoder.

3. The method of claim 1, wherein the converting of the first vector to the output sentence comprises, converting the first vector to the output sentence using the decoder, in response to a determination that the control word is not to be provided.

4. The method of claim 1, wherein the determining of whether the control word is to be provided comprises determining whether the control word is to be provided based on a similarity between the first vector and a reference vector.

5. The method of claim 1, wherein the determining of whether the control word is to be provided comprises:
recognizing a conversation pattern of the input sentence and a sentence that is input prior to the input sentence; and
determining whether the control word is to be provided based on whether the recognized conversation pattern corresponds to a reference pattern.

6. The method of claim 1, wherein the determining of whether the control word is to be provided comprises determining whether the control word is to be provided based on any one or any combination of whether a point in time at which the input sentence is input corresponds to a preset time, whether the input sentence is input in a preset conversational turn, or a preset frequency of providing the control word.

7. The method of claim 1, wherein the control word comprises a content word that is a target of an advertisement.

8. The method of claim 1, wherein the control word comprises a function word that is used to determine a structure of a sentence.

9. The method of claim 1, wherein the control word comprises a function word to perform a function in response to the input sentence.

10. A non-transitory computer-readable storage medium storing instructions that, when executed by a processor, cause the processor to perform the method of claim 1.

11. A method of training a natural language generation apparatus, the method comprising:
converting a training sentence to a first vector using a first neural network model-based encoder;
determining whether a control word is to be provided based on a criterion;
converting the first vector to an output sentence using a neural network model-based decoder based on whether the control word is to be provided; and
training the first encoder and the decoder by evaluating an accuracy of the output sentence.

12. The method of claim 11, wherein
the converting of the first vector to the output sentence comprises, in response to a determination that the control word is to be provided:
converting the control word to a second vector using a second neural network model-based encoder; and
converting the first vector to the output sentence based on the second vector using the decoder, and
the training of the first encoder and the decoder comprises training the first encoder, the second encoder and the decoder by evaluating the accuracy of the output sentence.

13. The method of claim 11, wherein the converting of the first vector to the output sentence comprises, converting the first vector to the output sentence using the decoder, in response to a determination that the control word is not to be provided.

14. The training method of claim 11, wherein
the determining of whether the control word is to be provided comprises determining whether the control word is to be provided based on a similarity between the first vector and a reference vector, and
the training of the first encoder and the decoder comprises modulating the criterion by evaluating the accuracy of the output sentence.

15. The method of claim 11, wherein
the determining of whether the control word is to be provided comprises:
recognizing a conversation pattern for the training sentence and a sentence that is input prior to the training sentence; and
determining whether the control word is to be provided based on whether the recognized conversation pattern corresponds to a reference pattern, and the training of the first encoder and the decoder comprises modulating the criterion by evaluating the accuracy of the output sentence.

16. The method of claim 11, wherein the training sentence comprises the input sentence and a natural language output sentence corresponding to the input sentence, and the evaluating of the accuracy of the output sentence comprises a comparison of the natural language output sentence with the output sentence.

17. An apparatus for generating a natural language, the apparatus comprising:
a processor configured to:
convert an input sentence to a first vector using a first neural network model-based encoder;
determine whether a control word is to be provided based on a criterion; and
convert the first vector to an output sentence using a neural network model-based decoder based on whether the control word is to be provided.

18. The apparatus of claim 17 further comprising:
a second neural network model-based encoder configured to convert the control word to a second vector, in response to a determination that the control word is to be provided, and
the decoder is configured to convert the first vector to the output sentence based on the second vector.

19. The apparatus of claim 18, further comprising a memory coupled to the processor, the memory comprising an instruction executed by the processor, and the memory being configured to store the input sentence, the first vector to which the input sentence is converted, the control word, one or more criterion used to determine whether the control word is to be provided, the second vector to which the control word is converted, a result obtained by combining the first vector and the second vector, and the output sentence.

20. An apparatus for training a natural language generation apparatus, the apparatus comprising:
a processor configured to:
convert a training sentence to a first vector using a first neural network model-based encoder;
determine whether a control word is to be provided based on a criterion;
convert the first vector to an output sentence using a neural network model-based decoder based on whether the control word is to be provided; and
train the first encoder and the decoder by evaluating an accuracy of the output sentence.

21. The apparatus of claim 20, further comprising a memory coupled to the processor, the memory storing an instruction executed by the processor to convert the training sentence to the first vector, to determine whether to provide the control word, to convert the first vector to the output sentence, and to evaluate the accuracy of the output sentence.
